(19) United States
(12) Patent Application Publication
(10) Pub. No.: US 2024/0181565 A1
(43) Pub. Date: Jun. 6, 2024

(54) LASER WELDING POSITION DETERMINATION

(71) Applicant: JAGUAR LAND ROVER LIMITED, Whitley, Coventry, Warwickshire (GB)

(72) Inventors: Mo AL-BADANI, Coventry, Warwickshire (GB); Clington ARULRAJ, Coventry, Warwickshire (GB); Joel DEVINE, Coventry, Warwickshire (GB); Jose ARANCIBIA, Coventry, Warwickshire (GB)

(21) Appl. No.: 18/551,849

(22) PCT Filed: Mar. 31, 2022
(86) PCT No.: PCT/EP2022/058696

§ 371 Date: Sep. 21, 2023

(30) Foreign Application Priority Data
Mar. 31, 2021 (GB) 2104569.5

(51) Int. Cl. B23K 26/082; B23K 26/70

(52) U.S. Cl. CPC B23K 26/082; B23K 26/707

(57) ABSTRACT

A laser welding process arranged to join each of a plurality of connection tabs to a respective one of a plurality of terminals comprises: a positioning step which sets in space, with respect to a first axis, respective positions of each connection tab and cell terminal; a measuring step comprising obtaining measurements indicative of the first axis position of each connection tab; and a welding step comprising determining, in accordance with the measurements, a respective focus distance to be used for the welding laser beam in joining each of the connection tabs to its respective cell terminal and, using the relevant respective laser beam focus distance determined, welding, in turn, each connection tab to its respective cell terminal.

### TECHNICAL FIELD

The present disclosure relates to a laser welding position determination. Aspects of the invention relate to a laser welding process, a controller, a computer program, a non-transitory computer readable storage medium, a signal and a laser welding system.

### BACKGROUND

When laser welding of a busbar connection tab to a cell terminal is performed through the connection tab, the margins in terms of over and/or under penetration of the welding laser beam may be fine. Specifically, the depths of material of the busbar connection tab and cell terminal may be small. Additionally, the materials used for one, other or both of the connection tab and cell terminal may be primarily selected for reasons other than their laser welding properties and may for instance be relatively highly absorbing of the laser energy, or of very different properties in this respect. Especially in such circumstances, uncertainty as regards the positioning of the cell and connection tab in a relevant direction may increase the likelihood of welding over or under penetration of the welding laser beam. Specifically, even careful calculation of appropriate welding laser beam properties (such as focus distance, burst duration and power etc), may be confounded where an inaccurate assumption as to the location of the connection tab and cell terminal is used. Under penetration may lead to welding failure, whilst overpenetration may cause the welding laser beam to enter the body of the cell, which may destroy the cell and/or be hazardous for operators and/or equipment.

It is an object of embodiments of the invention to at least mitigate one or more of the problems of the prior art.

### SUMMARY OF THE INVENTION

Aspects and embodiments of the invention provide a laser welding process, a controller, a computer program, a non-transitory computer readable storage medium, a signal and a laser welding system as claimed in the appended claims.

According to an aspect of the invention there is provided a laser welding process arranged to join each of a plurality of connection tabs to a respective one of a plurality of terminals, where each terminal is of a cell, for example a battery cell, and the cells are in a cell array and where each joining is performed using a welding laser beam, the process comprising: a measuring step comprising obtaining measurements indicative of a first axis position of each of the connection tabs; and a welding step comprising determining, in accordance with the measurements, a respective focus distance to be used for the welding laser beam in joining each of the connection tabs to its respective cell terminal and, using the relevant respective laser beam focus distance determined, welding, in turn, each connection tab to its respective cell terminal.

According to another aspect of the invention there is provided a laser welding process arranged to join each of a plurality of connection tabs to a respective one of a plurality of terminals, where each terminal is of a cell and the cells are in a cell array and where each joining is performed using a welding laser beam, the process comprising: a positioning step which sets in space, with respect to a first axis, respective positions of each connection tab and cell terminal; a measuring step comprising obtaining measurements indicative of the first axis position of each of the connection tabs; and a welding step comprising determining, in accordance with the measurements, a respective focus distance to be used for the welding laser beam in joining each of the connection tabs to its respective cell terminal and, using the relevant respective laser beam focus distance determined, welding, in turn, each connection tab to its respective cell terminal, where the incidence direction of the welding laser beam on each connection tab and cell terminal has a component direction in the first axis direction.

This process may alleviate the need for relatively high levels of accuracy in first axis positioning of each cell of the cell array at a predetermined nominal position for the performance of the laser welding process. To the extent that such high levels of accuracy are possible to achieve at all, they may be difficult and/or costly and/or time consuming to achieve. The process may allow account to be made for a degree of first axis inaccuracy in the absolute positioning of each cell and/or relative positioning of each cell with respect to the others and/or variation in the dimensions of the cells and/or their component parts. Additionally or alternatively, the process may facilitate the use of formations less tolerant of positional inaccuracies which might, particularly when using other systems, be more likely to lead to over or under penetration of the welding laser beam. For instance, it may be that a thinner cell terminal can be used and/or that a material of the cell terminal may be used which is more absorbent of laser energy and therefore tends to melt more rapidly under the influence of the welding laser beam. Specifically, because the process may at least largely remove the impact of misalignment of the cells in the first axis direction and/or take away uncertainty with regard to the actual position of each cell, more accurate welding may be achievable.

A longitudinal axis of each of cells may be arranged to be aligned with the first axis. The first axis may be a substantially vertical axis.

At least some of the connection tabs may be part of a busbar. The cells of the cell array may be oriented in a similar manner (e.g. with corresponding cell terminals facing the same direction and being substantially aligned with a common plane). The cell array may be combined with further cell arrays to form a supercell arrangement.

In some embodiments the process is performed with each connection tab at least partially covering its respective cell terminal and the welding occurring through each connection tab. Such arrangements may be convenient for the joining of a connection tab to a cell terminal of a cell, but may create a need for particular accuracy in terms of knowledge of cell positioning and/or welding laser beam penetration, which the process may be used to at least partially address. First, tolerances in terms of weld depth penetration may be small in view of limited depth of the connection tab and/or cell terminal. This may be further complicated where the connection tab and/or cell terminal comprise a material which has relatively high absorbency of the welding laser beam energy and is therefore melted rapidly by the welding laser beam and/or where the respective materials of the connection tab and cell terminal have different properties in this respect. Additionally, overpenetration of the welding laser beam may result in the welding laser beam entering the internals of the cell, potentially giving rise to hazards for operating personnel and/or equipment and rendering the cell irretrievably unusable.

In some embodiments the process is performed with the connection tab and cell terminal being in contact.

In some embodiments the material of each connection tab has a lower absorption of the welding laser beam at the wavelength used than the material of each cell terminal. The difference may for example be at least of an order of magnitude. It may be for example that the connection tab is copper and the cell terminal is steel. Such arrangement may make laser welding processes highly susceptible to inaccuracies in application time and/or focus distance for the welding laser beam arising from any incorrect assumption regarding the position of the cell in the first axis direction. That is, the welding laser beam may take considerably longer to melt a proportion of the connection tab than a corresponding portion of the underlying cell terminal.

In some embodiments the positioning step comprises positioning the connection tabs and cell terminals such that a common surface plane of the connection tabs to be welded is substantially normal to the first axis.

In some embodiments the process comprises forming the cell array, the forming comprising securing the cells relative to each other using adhesive. Such a process may be convenient in forming the cell array but may introduce the potential for first axis direction positional misalignment of at least one cell with respect to at least one other. It may be for instance that the cells are not perfectly aligned when they are adhered e.g. due to inaccurate placement when being adhered and/or a degree of positional adjustment allowed by the adhesive. In such circumstances the present process may assist in accounting for the misalignment.

A laser welding process according to any preceding claim comprising forming the cell array, the forming comprising installing the cells into a support structure where the support structure influences the set position of the cells and connection tabs with respect to the first axis. Such a process may be convenient in forming the cell array but may introduce the potential for first axis direction positional misalignment of at least one cell with respect to at least one other. It may be for instance that the support structure has variations in thickness in the first axis direction giving rise to similar variation in the positions of the cells and/or that a degree of discrepancy arises in the manner in which the cells are installed into the support structure. In such circumstances the present process may assist in accounting for the misalignment.

In some embodiments installing the cells into the support structure is performed using respective adhesive layers where the adhesive layers influences the set position of the cells and connection tabs with respect to the first axis. Such a process may be convenient in forming the cell array but may introduce the potential for first axis direction positional misalignment of at least one cell with respect to at least one other. It may be for instance that the adhesive layers are of inconsistent thickness in the first axis direction and/or that inconsistent compressive force is applied in installing the cells into the adhesive. In such circumstances the present process may assist in accounting for the misalignment.

In some embodiments the positioning step comprises deploying the cell array on a welding jig or platform which influences the set position of the cells and connection tabs with respect to the first axis. Such a process may be convenient in positioning and/or retaining the cells for the process but may introduce the potential for first axis direction positional misalignment of the cell array from a predetermined nominal position thereof. It may be for instance that the dimensions and/or positioning of the welding jig and/or platform is outside of design in a manner which affects the first axis direction positioning of the cell array. In such circumstances the present process may assist in accounting for the misalignment.

In some embodiments the positioning step comprises clamping each connection tab to its respective cell terminal. This may comprise applying a force having at least a component in the direction of the first axis. This may influence the position of one or more of the connection tabs with respect to their corresponding cell terminals in terms of first axis position and/or similarly the position of the cells themselves. Further, this influence may be inconsistent for different connection tab cell terminal pairs. In such circumstances the present process may assist in accounting for the misalignment.

In some embodiments the positioning step comprises setting in space with respect to a second axis and optionally a third axis a position of the connection tabs and cell terminals. The second axis may be perpendicular to the first axis. The third axis may be perpendicular to the first and second axes. It may be for instance that the first axis is a Z-axis and the second and third axes are the X-axis and the Y-axis respectively. It may be convenient and efficient to combine the positioning of the connection tabs and cell terminals in the first axis direction with positioning them in one or more additional axes directions too. It may also mean that the second and/or third axes positions are not adjusted after the first axis position is determined, which might give rise to unintended adjustment in the first axis position.

In some embodiments the measuring step comprises filtering the measurements with a noise filter. The noise filter may for instance be a low pass filter.

In some embodiments the measuring step comprises obtaining multiple measurements for each connection tab, the measurements being indicative of the first axis position of the respective connection tab, by performing the measurements at different locations on each connection tab, calculating an average value of the measurements for each connection tab and using each respective average value as indicative of the first axis positions of the respective connection tab. Such a technique may increase the accuracy of the relevant first axis position determined.

In some embodiments each measurement of the measuring step comprises measuring the distance between a reference point and the connection tab. The reference point may be a part of a measuring device arranged to perform the measuring step. The relevant part of connection tab may be its top surface (i.e. the surface on which it is intended that the welding laser beam will be incident). The relevant parts of each connection tab may be arranged to comprise a common surface plane that is substantially perpendicular to the first axis.

In some embodiments the measuring step may comprise outputting a deviation from a nominal distance between the reference point and the connection tab.

In some embodiments the incidence direction of the welding laser beam on each connection tab is substantially aligned with the first axis direction.

In some embodiments obtaining measurements indicative of the first axis direction position of each connection tab comprises moving relative to the connection tabs a measuring device arranged to perform the measurements and performing the measurements for at least some of the connection tabs using the measuring device and doing so at substantially the point of closest approach to the respective connection tab. The measuring device may for instance run on a rail and may sweep along in a continuous manner taking measurements as it goes. The direction of movement of the measuring device may for instance be in the second or third axis direction. There may be multiple instances of the measuring device and they may operate simultaneously, sequentially or in groups. Each measuring device may perform the measurements for a sub-set of the connection tabs (e.g. for a single column thereof). Using substantially the points of closest approach may increase the accuracy of the measurements and/or facilitate each measurement being taken substantially in the first axis direction.

In some embodiments the measuring step comprises determining the locations at which the measuring device performs the measurements for each of the connection tabs for which it performs measurement indexed in accordance with the measuring device recognising patterns in variation in sensed range as corresponding to features of clamping formations clamping each connection tab to its respective cell terminal. It may be for instance that the measuring device scans distance continuously and so is able to recognise significant changes in distance and/or patterns in changes of distance as corresponding to the clamping formations which themselves may be indicative of the locations of the connection tabs in the relevant axis direction. The clamping formation may for instance be sprung loaded or have another mechanism allowing passive or active relocating of the clamping formations to suit the precise positions of the cell terminals. Such a technique may mitigate errors which may occur where for instance indexing is performed based on elapse of a fixed distance and the distance between connection tabs does not in reality perfectly reflect this fixed distance. Such errors may lead to the taking of measurements at non-optimal locations and in some instances even missing the relevant connection tab entirely with one or more measurements. Such difficulties may become more acute with later measurements for a given cell array as a consequence of the cumulation of errors.

In some embodiments the measuring step is performed for some or all of the connection tabs prior to the welding step being performed for those some or all connection tabs and the measuring step is performed for one or more other connection tabs whilst the welding step is performed for the some or all connection tabs. This may reduce the total time that the process takes and therefore improve efficiency.

In some embodiments the welding step comprises setting for each welding operation of each connection tab and corresponding cell terminal a focus distance for the corresponding welding laser beam in accordance with the corresponding measurement or measurements and welding the relevant connection tab to the corresponding cell terminal using the corresponding welding laser beam, where the incidence direction of each corresponding welding laser beam has a component direction in the first axis direction.

In some embodiments there is one welding laser device arranged to deliver sequentially each of the welding laser beams.

In some embodiments the one welding laser device may remain substantially static whilst welding at least a plurality of the connection tabs to their corresponding cell terminals and the welding step may comprise adjusting one or more optical elements of the welding laser device to accommodate the different paths necessary for the respective welding laser beams. In some embodiments the welding laser device, or at least a welding head thereof may be subsequently moved to a position from which it welds another plurality of the connection tabs to their corresponding cell terminals.

In some embodiments the one welding laser device and the one or more measuring devices are arranged so that they can pass one another when one, other or both are moving relative to the connector tabs. This may in some embodiments allow the measuring device or devices to return to a beginning of their respective runs and to at least begin performing a measuring step for another cell array where to do so it is necessary or desirable that it pass the welding laser device which may still be performing the welding step for a different cell array.

In some embodiments the cell terminal of each cell is one of two cell terminals of each cell, the two cell terminals of each cell being on opposite sides thereof and the welding process comprises duplicating the measuring step and the welding step such that both cell terminals of each cell undergo the welding process based on the same positioning step. Where for instance the spacing between the two cell terminals can be known to sufficient accuracy, the measurement of the first axis direction position of one may allow the first axis direction position of the other to be inferred. This may mean that there is no need to duplicate the measurement step.

In some embodiments the cell terminal of each cell is one of two cell terminals of each cell, the two cell terminals of each cell being on opposite sides thereof and the welding process comprises duplicating the welding step such that both cell terminals of each cell undergo the welding process based on the same positioning and measuring steps. Utilising the same positioning step may mean that there is no further adjustment to the position of the relevant cells between the two welding steps. This may reduce the potential for additional uncertainty in the true first-axis direction position of the relevant connection tab being introduced by a positional adjustment between welding operations where a single measuring step is being relied upon.

In some embodiments the measuring step is performed using a laser rangefinder. This may be the measuring device. The laser rangefinder may have a 100 kHz sampling period or higher.

In some embodiments when respective measurements are performed, the incidence direction of a measuring laser beam from the laser rangefinder on the respective connector tab is substantially aligned with the first axis direction.

According to yet another aspect of the invention there is provided a controller arranged to control performance of a laser welding process arranged to join each of a plurality of connection tabs to a respective one of a plurality of terminals, where each terminal is of a cell and the cells are in a cell array and where further each joining is performed using a welding laser beam, the controller comprising; an input means arranged to receive measurements indicative of a first axis position of each of the connection tabs; and a processing means arranged to determine, in accordance with the measurements, a respective focus distance to be used for the welding laser beam in joining each of the connection tabs to its respective cell terminal; and an output means via which the processing means controls performance of welding, in turn, each connection tab to its respective cell terminal, using for each joining the relevant respective laser beam focus distance determined, where the incidence direction of the welding laser beam on each connection tab and cell terminal has a component direction in the first axis direction.

In some embodiments the processing means is arranged to control the process of obtaining the measurements.

In some embodiments the processing means is arranged to control a positioning step which sets in space, with respect to the first axis, respective positions of each connection tab and cell terminal.

According to a further aspect of the invention there is provided a computer program that, when read by a computer, causes performance of the process as described above.

According to a still further aspect of the invention there is provided a non-transitory computer readable storage medium comprising computer readable instructions that, when read by a computer, cause performance of the process as described above.

According to a yet further aspect of the invention there is provided a signal comprising computer readable instructions that, when read by a computer, cause performance of the process as described above.

According to a yet further aspect of the invention there is provided a laser welding system arranged to join each of a plurality of connection tabs to a respective one of a plurality of terminals, where each terminal is of a cell and the cells are in a cell array and where further each joining is performed using a welding laser beam, the apparatus comprising a measuring device and a welding device, the measuring device being arranged to obtain measurements indicative of the first axis position of each of the connection tabs, and the welding device being arranged to weld, in turn, each connection tab to its respective cell terminal, where a respective focus distance used by the welding laser beam in joining each of the connection tabs to its respective cell terminal is determined in accordance with the measurements, and where the incidence direction of the welding laser beam on each
connection tab and cell terminal has a component direction in the first axis direction and where further each of the connection tabs and cell terminals have respective first axis positions set in space.

In some embodiments the welding system comprises a positioning system arranged to perform the setting in space of the connection tabs and cell terminals.

In some embodiments the positioning system comprises a clamping assembly arranged to clamp each connection tab to its respective cell terminal.

In some embodiments the measuring device comprises a laser rangefinder which it uses to obtain the measurements.

In some embodiments the welding system comprises multiple measuring devices, and each is used to perform the measurement for a respective group of the connection tabs.

In some embodiments the welding system is arranged so that when respective measurements are performed, the incidence direction of a measuring laser beam from the laser rangefinder on the respective connector tab is substantially aligned with the first axis direction.

In some embodiments the measuring device is arranged to perform the measurements for at least some of the connection tabs and to do so at substantially the point of closest approach to the respective connection tab whilst moving relative to the connection tabs. There may be multiple instances of the measuring device operating simultaneously, sequentially or in groups. Each measuring device may perform the measurements for a sub-set of the connection tabs (e.g. for a single column thereof).

In some embodiments the one welding laser device and the one or more measuring devices are arranged so that they can pass one another when one, other or both are moving relative to the connector tabs.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors,
optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1a-1c show various views of a cell which may be welded to a connector tab in accordance with embodiments of the invention;

FIG. 2 shows a perspective view of a connector tab and cell to be joined by welding in accordance with an embodiment of the invention;

FIG. 3 shows a side view of a laser welding system according to an embodiment of the invention;

FIG. 4 shows a perspective view of a welding laser device in accordance with an embodiment of the invention; and

FIG. 5 shows a controller in accordance with an embodiment of the invention.

### DETAILED DESCRIPTION

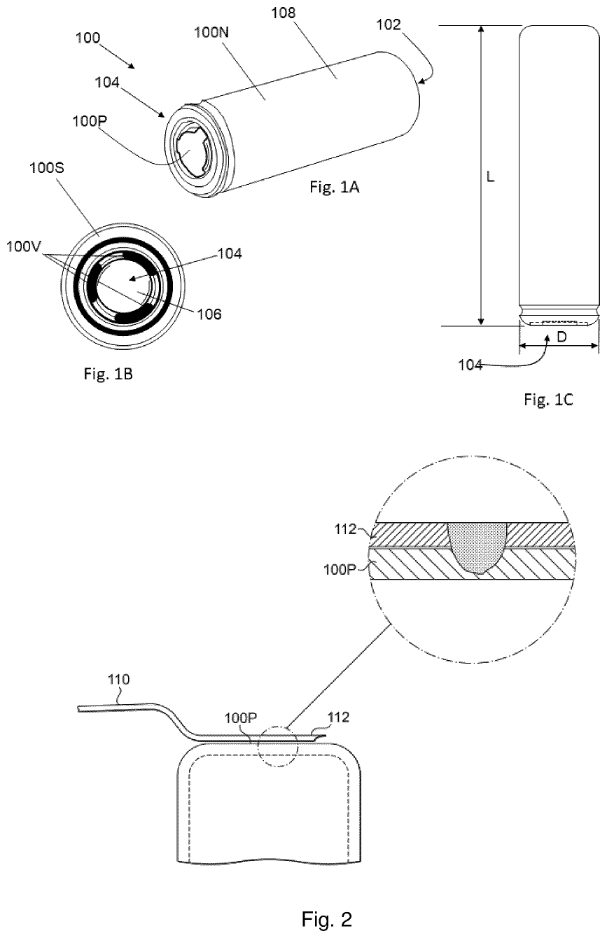

FIGS. 1A-C show different views of a cylindrical cell 100. Cylindrical cells 100 are available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used in embodiments of the present invention.

As will be well understood, the cell 100 comprises a positive terminal 100P, a negative terminal 100N, and vent means 100V. The positive terminal 100P is provided by a steel end cap 106 in a central region of a first end 104 of the cell 100, and the negative terminal 100N is provided by a steel cylindrical case 108. The steel cylindrical case 108 covers the second end 102, the entire cylindrical surface between the first and second ends, and a peripheral region 100S of the first end 104. The peripheral region of the first end surface may also be referred to as a “shoulder” region 100S of the first end 104. In commercially-available cells, it is sometimes the case that the end cap that defines the positive terminal 100P on the first end 104 protrudes beyond the shoulder region of the first end 104, although this is not the case in the cell shown in FIG. 1. This allows a substantially planar connector to be connected to the positive terminal 100P and not the negative terminal 100N. As will be
understood, it is important to avoid direct electrical connections between the positive 100P and negative 100S terminals, as such connections create a short circuit which may damage the cell 100.

As shown in FIG. 1, the cell 100 comprises three vent means 100V in the first end 104, between the steel end cap 106 that defines the positive terminal 100P and the shoulder region 100S of the steel cylindrical case 108. The vent means 100V are gaps that are covered by a material that will rupture to allow hot gases to escape through the gap between the end cap 106 and steel cylindrical case 108 in the event of excessive pressure occurring inside the cell 100, thereby mitigate against the risk of the cell 100 exploding.

It may be desired to incorporate multiple examples of the cell 100 into a cell array which may for instance comprise a battery module. In this case it may be that the positive terminals 100P of the cells 100 are connected in parallel by a positive busbar 110 connected to each positive terminal 100P by respective connection tabs 112 of the positive busbar 110 (see FIG. 2). Similarly the negative terminals 100N of the cells 100 are connected in parallel by a negative busbar connected to each negative terminal 100N by respective connection tabs of the negative busbar. The connection of each connection tab to its respective terminal 100P, 100N is by laser welding. The laser welding is performed through the connection tab overlaying the cell terminal to join the two while they are in contact. In this case the terminals 100P, 100N are of steel and the connection tabs are of copper. Such arrangements may have particularly fine margins in terms of appropriate welding laser beam operational parameters if under and over penetration of the welding laser beam is to be avoided. Specifically, copper is more reflective to the welding laser beam than steel and copper has a higher melting point than steel. The process may therefore be particularly sensitive to any misalignment from a nominal position of each individual cell and/or its relevant terminal within the cell array in a first axis direction where the welding laser beam is applied in a direction having a component in the first axis direction. In such cases, where an assumption is made that every individual cell and/or its relevant terminal is located at the nominal position, and the focus distance for the welding laser beam is selected on that basis, instances of under or over penetration of the welding laser beam may occur.

The focus distance may be defined as the distance from a point on a welding laser device (e.g. its welding head), to a surface of a process site. At the point where the welding laser beam intercepts that process site, the welding laser beam may be considered to define or generate a spot of the welding laser beam. The position of this spot may be termed the ‘welding focus’. The focus of the laser beam itself may be termed the ‘laser focus’ and typically the laser focus is displaced from the welding focus by a distance along the axis of the welding laser beam. Sometimes, the laser focus is positioned outside the workpiece further towards a source of the laser than the welding focus, in which case the welding laser beam becomes progressively less focused as it encounters and travels beyond the welding focus. This may have the effect of directing less intense energy deeper into the workpiece, which may be advantageous if the deeper material requires less energy than the surface material in order to form the weld. Alternatively, the laser focus may be positioned within the workpiece, further away from the source of the laser than the welding focus, in which case the laser beam may become more focused within
the workpiece beyond the welding focus. This may have the effect of directing more intense energy deeper into the workpiece which may be advantageous if the deeper material requires greater energy than the surface material for formation of the weld pool. In the case of the welding of copper tabs to steel cells, it may be the first material encountered by the beam that requires more energy for welding because of its greater reflectivity than the deeper layer of steel. Hence, for the welding of copper tabs onto steel cells, the laser focus may be formed outside the workpiece by a distance of substantially 0.5 mm from the copper tab surface. This may avoid the overheating of the steel and may reduce weld spatter and improve the quality of the final weld. It may also reduce the risk that the weld may penetrate the steel casing of the cell, which is undesirable. Therefore, in order for the process to adequately control these parameters, an accurate measurement of the focus distance may be desirable.

Many factors may create uncertainty regarding the precise position in space (and in particular with respect to the first axis direction) of an individual cell 100 and/or its terminals 100P, 100N. First, the cells 100 and/or cell terminals 100P, 100N themselves may vary somewhat in their dimensions (e.g. there may be variation in the lengths of the cells 100 and/or in the thicknesses of the cell terminals 100P, 100N). Such variation may be unintentional or may be within design tolerance. Further, the process of forming the cell array may be susceptible to creating off-nominal positioning of cells in the first axis direction, including relative misalignment between cells 100. It may be for example that the cells 100 of the cell array are secured relative to each other and/or are installed into a support structure for the cell array using adhesive. In this case, any inaccuracies in the positioning of the cells 100 may result in them being set in an off-nominal position. Further, the support structure itself may influence the set position of the cells 100 with respect to the first axis, and (for instance due to finite manufacturing tolerances) may give rise to off-nominal positioning of the cells 100 with respect to the first axis direction and/or variation with respect to the first axis direction positioning across cells 100. Additionally, the cell 100, cell array and/or support structure may be inaccurately positioned (or is only positioned to within a degree of tolerance) for the laser welding process. It may be for instance that the cell 100, cell array and/or support structure is positioned using a positioning system including a welding jig or platform. This welding jig or platform may be misaligned from nominal in the first axis direction itself and/or may mount and/or support the cell 100, cell array and/or support structure in a misaligned manner from nominal with respect to the first axis direction. Still further, the connection tabs may be clamped to the respective cell terminals 100P, 100N using a clamping assembly and this process may locate one or more of the connection tabs and/or cell terminals 100P, 100N away from nominal alignment with respect to the first axis direction.

In accordance with the present embodiment, the laser welding process is performed by a laser welding system shown generally at 120 having particular adaptations so as to mitigate or overcome the difficulties presented by uncertainty in the precise first axis direction positioning of each cell 100. More specifically, the laser welding system 120 comprises a measuring device comprising a laser rangefinder 122, in addition to a welding laser device 124. The laser rangefinder 122 is used in determining actual connection tab positions with respect to the
first axis direction, and this information is used on a per connection tab/per cell 100 basis to set the focus distance for a respective welding laser beam from the welding laser device 124.

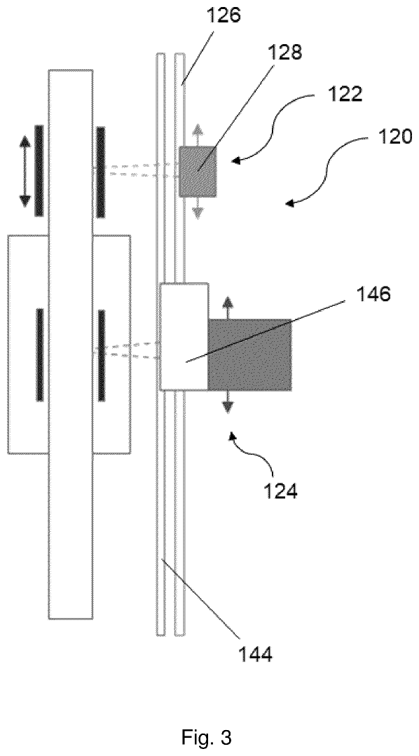

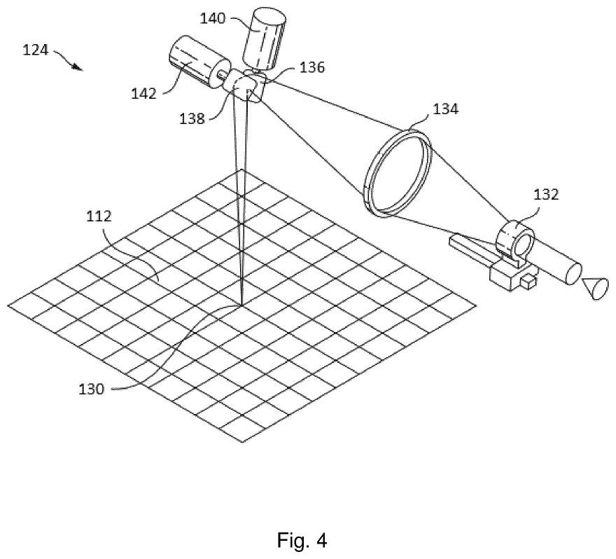

An example laser welding process for the positive busbar 110 positive connection tabs 112 and the corresponding positive terminals 100P of the cells 100 of the cell array is discussed below with reference to FIGS. 3 and 4.

Initially the cell array is formed by securing the cells 100 relative to each other using adhesive. Alternative methods may however be used. In some embodiments for instance, the cells 100 are secured relative to each other by a carrier into which the cells are placed and wherein cells 100 may be fixed by adhesive. The carrier may provide location features for holding individual cells in position within the array. The cells 100 are arranged in the cell array so as to form, for example, five columns and twelve rows, to give a total of sixty cells 100 in the cell array. The cells 100 are all oriented in the same manner and are arranged side by side with the top surfaces of the positive connection tabs 112 substantially aligned to a common surface plane.

A positioning step is performed which puts the cell array and connection tabs 112 in position for laser welding. The positioning step sets in space, with respect to the first axis (which may be considered the Z-axis), the position of the cell array and the connection tabs 112 of the positive busbar 110. In this embodiment it is assumed that the first axis is a vertical axis. Nonetheless, in other embodiments the first axis may be offset from vertical and could for instance be horizontal. The positioning step also sets the position of the cell array and connection tabs 112 in space with respect to a second axis and a third axis. The second and third axes are perpendicular to each other and to the first axis. In this embodiment the second and third axes are horizontal. The positioning step is achieved through use of a positioning system comprising a welding jig (into which the cell array and connection tabs 112 are placed) and the action of a clamping assembly. With the cell array and connection tabs 112 placed therein, the welding jig is arranged to secure the cell array in an orientation such that the longitudinal axis of the cells 100 is arranged vertically and therefor is aligned with the first axis. Further, such that the top surfaces of the positive connection tabs 112 are perpendicular to the first axis. Similarly, the welding jig supports the positive busbar 110 in such a manner that a common surface plane of the connection tabs 112 is substantially perpendicular to the first axis. The clamping assembly applies a force on the connection tabs 112 towards their respective positive terminals 100P, bringing them, where they were not already, into contact therewith. In this embodiment the clamping assembly comprises an array of cylindrical bodies, one for each cell 100 in the cell array, having an end surface which is applied to the connection tab 112 and an open centre through which measuring and welding steps are performed with respect to each connection tab 112 and corresponding positive terminal 100P.

With the cell array and connection tabs 112 positioned for laser welding, a measuring step is performed by the measuring device. The measuring device comprises a rangefinder repositioning assembly and a laser rangefinder 122 comprising a laser rangefinder source (not shown) and a laser rangefinder receiver (not shown). The rangefinder repositioning assembly comprise a rangefinder rail 126 and a rangefinder cart 128 on which the
laser rangefinder 122 is mounted. The rangefinder cart 128 comprises running wheels (not shown) which support the rangefinder cart 128 on the rangefinder rail 126 and at least one of which is selectively driven by a motor (not shown) also provided on the rangefinder cart 128, to selectively reposition the rangefinder cart 128 (and so the laser rangefinder 122) along the rangefinder rail 126. The rangefinder rail 126 is aligned with the second axis which may correspond to the direction in which the columns of the cell array run. The rangefinder rail 126 is located with respect to the cell array when mounted in the welding jig such that the laser rangefinder source is positionable so as to be substantially aligned in the first axis direction with each of the cells 100 in a particular column of the cell array, and further such that the positive connection tab 112 for the relevant cell 100 would be between the positive terminal 100P of that cell 100 and the laser rangefinder source. In the measuring step, the rangefinder cart 128 is progressively moved along the rangefinder rail 126 such that it successively encounters closest points of approach to each of the positive connection tabs 112 in the relevant column. As it travels, the laser rangefinder source emits a measuring laser beam towards the cell array. When the measuring laser beam is incident on a surface, it is reflected therefrom and received by the laser rangefinder receiver. The time taken between emission of the measuring laser beam from the laser rangefinder source and its detection by the laser rangefinder receiver is indicative of the distance travelled by the measuring laser beam and therefore the position of the surface with respect to the first axis.

At intervals, the measuring laser beam will be reflected from an instance of the cylindrical bodies of the clamping assembly and thereafter from the corresponding positive connection tab 112. A received signal at the rangefinder receiver where the measuring laser beam is reflected from an instance of the cylindrical bodies may be distinctive (e.g. the cylindrical body may define a raised section such that the distance travelled by the measuring laser beam may be characteristically and reliably reduced). Similarly, there may be a characteristic increase in distance travelled as the measuring laser beam is first reflected by an instance of the cylindrical bodies and then by the corresponding positive connection tab 112 via the open centre of the relevant cylindrical body. In the present embodiment, one or more such features are recognised and used to index the interval at which measurements of the distance travelled by the measuring laser beam are taken to be indicative of the first axis position of respective positive connection tabs 112. At locations determined in accordance with the indexing, multiple distance determinations are made for each of the positive connection tabs 112. The laser rangefinder delivers the measuring laser beam for these determinations at positions around a point taken to be that of closest approach of the laser rangefinder 122 to the centre of the respective positive connection tab 112. The distance determinations are made over a distance in the second axis direction of approximately 1 mm and at 100 kHz as the rangefinder cart 128 moves continuously along the rangefinder rail 126. In each case, the incidence direction of a measuring laser beam from the laser rangefinder source on the respective positive connector tab 112 is substantially aligned with the first axis direction. In respect of each positive connection tab 112, an average of the distance determinations made for that positive connection tab 112 is determined and the average is taken to be indicate the position of the relevant positive connection tab 112 with respect to the first axis.

Multiple instances (in this case five) of the measuring device as described above are provided, one for each column of the cell array. Thus, a first axis position is determined for each of the positive connection tabs 112 in the cell array during the measuring step.

Following the measuring step, a welding step is performed. The welding step comprises determining, in accordance with the position determined for each positive connection tab 112, a respective focus distance to be used for the welding laser beam in joining each of the positive connection tabs 112 to its respective positive terminal. As will be appreciated, where the relevant positive connection tab 112 is determined to be further away, the focus distance is correspondingly determined to be further away and vice versa. The welding step further comprises using the relevant respective welding laser beam focus distance determined, for welding, in turn, each positive connection tab 112 to its respective positive terminal 100P.

The welding laser device 124 and accompanying welding repositioning assembly is described further below.

The welding laser device 124 comprises a welding laser source (not shown), which produces the welding laser beam. By means described further below, the welding laser device 124 delivers the welding laser beam to a process site 130 defined as an area of the relevant positive connection tab 112, and through it the positive cell terminal 100P, upon which the welding laser beam is incident at the relevant time. At the point of its interception of the process site 130, the welding laser beam may be considered to define or generate a spot of the welding laser beam.

The welding laser device 124 comprises an optical system via which the welding laser beam passes from its source to the process site 130. The optical system comprises, in sequential order from the source (not shown) to the process site 130, a diverging lens 132, a converging lens 134, a first mirror 136 and a second mirror 138. Each of the mirrors 136, 138 is rotatable about a single axis under the control of a respective galvanometer 140, 142. The axes about which the mirrors 136, 138 are rotated are mutually perpendicular, so that the first mirror 136 controls the location of the process site 130 with respect to the second axis direction (in this case the X-axis direction) and the second mirror 138 controls the location of the process site 130 with respect to the third axis direction (in this case the Y-axis direction). The diverging lens 132 is movable along an axis parallel to the initial direction of the welding laser beam from the laser source, and may therefore be considered an adjustable focusing lens. This allows the position of the focal point of the welding laser beam to be adjusted in the first axis direction (in this case the Z-axis direction). It will be appreciated that in other embodiments the order of the provision of the various components of the optical system may be adjusted (for instance the order of the first 136 and second 138 mirrors may be reversed).

In the present embodiment the welding laser source is a single-mode infra-red laser operating at substantially 1070 nm wavelength. It is controlled to emit the welding laser beam in a discontinuous manner, in this case in periodic bursts. The power of the welding laser beam emitted is substantially 600 W.

The optical system (and specifically the diverging lens 132 position) is controlled to focus the welding laser beam at a desired position with respect to the first axis direction. In most cases the welding laser beam will be focused at or near to the process site 130 and will have a spot size between 30 and 45 micro meters at the process site 130. Focusing at a point other than the process site 130 may be advantageous in certain regards e.g. in controlling penetration and/or reducing sputter. The optical system (and specifically the diverging lens 132 position) is controlled to compensate for angular adjustments of the welding laser beam (e.g. as resulting from second axis and/or third axis position adjustments of the welding laser beam as discussed further below) in maintaining the desired focus at the process site 130.

The welding repositioning assembly comprises a welding rail 144 and a welding cart 146 on which the welding laser device 124 is mounted. The welding cart 146 comprises running wheels (not shown) which support the welding cart 146 on the welding rail 144 and at least one of which is selectively driven by a motor (not shown) also provided on the welding cart 146, to selectively reposition the welding cart 146 (and so the welding laser device 124) along the welding rail 144.

The welding rail 144 is aligned with the second axis which corresponds to the direction in which the columns of the cell array run. The welding rail 144 is located with respect to the cell array when mounted in the welding jig such that the welding laser source is positionable so as to be substantially aligned in the first axis direction with each of the cells 100 in the cell array and further such that the positive connection tab 112 for the relevant cell 100 would be between the positive terminal 100P of that cell 100 and the welding laser source. In the welding step, the welding cart 146 is periodically moved at intervals along the welding rail 144. Between the movements, the welding laser device 124 performs welding on a proportion of the positive connection tabs 112 and their corresponding positive terminals 100P to which it will not be nearer on another occasion. This includes such positive connection tabs 112 and positive terminals 100P in each of the columns of the cell array. The optical system (and specifically the first 136 and second 138 mirrors) is controlled to steer the welding laser beam both in performing welding and for re-siting of the welding laser beam for welding the various positive connection tabs 112 and corresponding positive terminals 100P whilst the welding laser device 124 is stationary. The incidence direction of the welding laser beam on each positive connection tab 124 and positive terminal 100P is substantially aligned with the first axis direction. Thus in this case, the incidence direction has not only a component in the first axis direction but substantially is the first axis direction.

The rangefinder carts 128 and welding cart 146, including the equipment they carry, are arranged so that they can all pass one another travelling in the second axis direction. This can be achieved by offsetting them, at least to some extent, in the first and or third axis directions and optionally shaping them to have mutually accommodating forms. This allows, for instance, for the measuring step to be performed prior to the welding step, and then for the laser rangefinders 122 to be moved past the welding laser device 124 (e.g. to a location further upstream in a production line) and be used for performing a further instance of the measuring step on
another cell array or another part of the cell array, whilst for instance the welding step is performed based on the measuring step already completed.

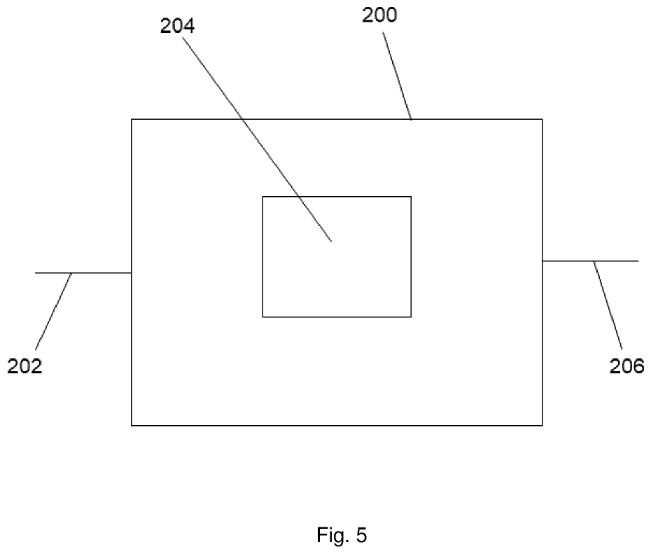

In the present embodiment the various controllable operations discussed above are controlled by a controller 200 (see FIG. 5). The controller 200 has an input means 202, a processor means 204 and an output means 206. In this case the controller 200 is operable to control the power of the welding laser beam and to selectively switch the welding laser beam on and off via control of the welding laser source. The controller 200 is also operable to selectively switch on and off the measuring laser beam. The controller 200 is also operable to adjust the focal position of the welding laser beam in dependence on the measurements indicative of the first axis position of the relevant connection tab by moving the diverging lens 204, and to adjust positions of the spot of the welding laser beam by controlling the angular positions of the first and second mirrors 136, 138 via the respective galvanometers 140, 142. The controller 200 is also operable to control the process of obtaining the measurements and indeed the positioning step which proceeds it. In particular, the controller 200 controls an automated operation of the positioning system to load the cell array into the welding jig and the clamping assembly to clamp the connection tabs against the cell terminals, as well as controlling operation of the rangefinder carts 128. The welding cart 146 is also controlled by the controller 200.

The processor means 204 recognises the features associated with the presence of the cylindrical bodies of the clamping assembly and uses them to index the interval at which measurements of the distance travelled by the measuring laser beam are taken to be indicative of the first axis position of respective connection tabs. As will be appreciated, suitable inputs are received by the controller 200 and in particular the processing means 204 via the input means 202 in order to instruct such control and/or in order that such controls may be calculated by the processing means 204. Such inputs may for instance have been programmed by a user or system and may be inputted via the input means 202 from a sensor (including the laser rangefinder receiver), a memory, a server, direct user input on a user interface or the like. The output means 206 provides the communication paths via which the controller 200 exerts the control as determined by the processing means 204. Thus, the output means 206 is used by the processing means 204 controls performance of welding, in turn, each connection tab to its respective cell terminal, using for each joining the relevant respective laser beam focus distance determined.

As will be appreciated, in the example described above, discussion of welding only the positive connection tabs 112 to the positive terminals 100P is provided. However, the process may naturally be duplicated with respect to the negative connection tabs and corresponding negative terminals 100N. Further, this duplication may occur simultaneously or at least with some degree of overlap in time. Further, both processes may be based on the same positioning step, that is one positioning step is performed on which the welding step is based for both the positive and negative terminals. Optionally, only one measuring step may be performed per cell for the two welding steps too. That is, where it is considered that the distance between connection tabs for the positive and negative terminals is known with sufficient accuracy, a measurement step performed with respect to only one of the connection tabs may be used to determine the position of the other.

It will be appreciated that the arrangement of FIG. 3 may also be rotated such that the rangefinder cart 128 and welding cart 146 lie substantially alongside the cells which are also oriented with their longitudinal axes arranged substantially horizontally. In this case the welding laser beam travels substantially horizontally towards the cells rather than vertically. Such an arrangement may more easily allow two welding laser systems 120 to operate (e.g. simultaneously) one on either side of the array of cells, (e.g. for welding both positive terminals 100P and negative terminals 100N of the cells 100).

It will be appreciated that embodiments of the present invention can be realised in the form of hardware, software or a combination of hardware and software. Any such software may be stored in the form of volatile or non volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A laser welding process arranged to join each of a plurality of connection tabs to a respective one of a plurality of terminals, where each terminal is of a cell and the cells are in a cell array and where each joining is performed using a welding laser beam, the laser welding process comprising:
a positioning step which sets in space, with respect to a first axis, respective positions of each connection tab and cell terminal;
a measuring step comprising obtaining measurements indicative of a first axis position of each of the plurality of connection tabs;
and a welding step comprising determining, in accordance with the measurements, a respective focus distance to be used for the welding laser beam in joining each of the plurality of connection tabs to its respective cell terminal and, using a relevant respective laser beam focus distance determined, welding, in turn, each connection tab to its respective cell terminal, where an incidence direction of the welding laser beam on each connection tab and cell terminal has a component direction in a direction of the first axis.

2. The laser welding process according to claim 1, performed with each connection tab at least partially covering its respective cell terminal and the welding occurring through each connection tab.

3. The laser welding process according to claim 1, where a material of each connection tab has a lower absorption of the welding laser beam at a wavelength used than the material of each cell terminal.

4. The laser welding process according to claim 1, further comprising forming the cell array, the forming comprising installing the cells into a support structure where the support structure influences a set position of the cells and connection tabs with respect to the first axis.

5. The laser welding process according to claim 1, where the positioning step comprises deploying the cell array on a welding jig or platform which influences a set position of the cells and connection tabs with respect to the first axis.

6. The laser welding process according to claim 1, where the positioning step comprises clamping each connection tab to its respective cell terminal.

7. The laser welding process according to claim 1, wherein the measuring step comprises obtaining multiple measurements for each connection tab, the measurements being indicative of a first axis position of the respective connection tab, by performing the measurements at different locations on each connection tab, calculating an average value of the measurements for each connection tab and using each respective average value as indicative of the first axis positions of the respective connection tab.

8. The laser welding process according to claim 1, wherein the incidence direction of the welding laser beam on each connection tab is substantially aligned with the first axis.

9. The laser welding process according to claim 1, where obtaining measurements indicative of the first axis position of each connection tab comprises moving relative to the plurality of connection tabs a measuring device arranged to perform the measurements and performing the measurements for at least some of the plurality of connection tabs using the measuring device and doing so at substantially the point of closest approach to the respective connection tab.

10. The laser welding process according to claim 1, where the cell terminal of each cell is one of two cell terminals of each cell, the two cell terminals of each cell being on opposite sides thereof and the laser welding process further comprises:
duplicating the measuring step and the welding step such that both cell terminals of each cell undergo the laser welding process based on the same positioning step; or
duplicating the welding step such that both cell terminals of each cell undergo the laser welding process based on the same positioning and measuring steps.

11. A controller arranged to control performance of a laser welding process arranged to join each of a plurality of connection tabs to a respective one of a plurality of terminals, where each terminal is of a cell and the cells are in a cell array and where further each joining is performed using a welding laser beam, the controller comprising;
an input means arranged to receive measurements indicative of a first axis position of each of the plurality of connection tabs;
a processing means arranged to determine, in accordance with the measurements, a respective focus distance to be used for the welding laser beam in joining each of the plurality of connection tabs to its respective cell terminal; and
an output means via which the processing means controls performance of welding, in turn, each connection tab to its respective cell terminal, using for each joining a relevant respective laser beam focus distance determined, where an incidence direction of the welding laser beam on each connection tab and cell terminal has a component direction in a direction of the first axis.

12. A computer program that, when read by a computer, causes the computer to perform the laser welding process as claimed in claim 1.

13. A laser welding system arranged to join each of a plurality of connection tabs to a respective one of a plurality of terminals, where each terminal is of a cell and the cells are in a cell array and where further each joining is performed using a welding laser beam, the apparatus comprising a measuring device and a welding device, the measuring device being arranged to obtain measurements indicative of a first axis position of each of the plurality of connection tabs, and the welding device being arranged to weld, in turn, each connection tab to its respective cell terminal, where a respective focus distance used by the welding laser beam in joining each of the plurality of connection tabs to its respective cell terminal is determined in accordance with the measurements, and where an incidence direction of the welding laser beam on each connection tab and cell terminal has a component direction in a first axis direction and where further each of the plurality of connection tabs and cell terminals have respective first axis positions set in space.

14. The laser welding system according to claim 13, further comprising a positioning system arranged to perform the setting in space of the plurality of connection tabs and cell terminals.

15. The laser welding system according to claim 13, where the laser welding system comprises multiple measuring devices, and each is used to perform the measurement for a respective group of the plurality of connection tabs.

16. The laser welding process according to claim 4, further comprising installing the cells into the support structure is performed using respective adhesive layers where the adhesive layers influence the set position of the cells and connection tabs with respect to the first axis.

17. The laser welding process according to claim 9, where the measuring step comprises determining locations at which the measuring device performs the measurements for each of the plurality of connection tabs for which it performs measurement indexed in accordance with the measuring device recognising patterns in variation in sensed range as corresponding to features of clamping formations clamping each connection tab to its respective cell terminal.

18. The laser welding system according to claim 14, where the positioning system comprises a clamping assembly arranged to clamp each connection tab to its respective cell terminal.
